(19) United States
(12) Patent Application Publication
(10) Pub. No.: US 2022/0018476 A1
(43) Pub. Date: Jan. 20, 2022

(54) Triflow Pipe Fitting

(71) Applicant: Fluidtrol Processing Technologies, Inc., Huntsville, AL (US)

(72) Inventor: David Michael Hamilton, Huntsville, AL (US)

(73) Assignee: Fluidtrol Processing Technologies, Inc., Huntsville, AL (US)

(21) Appl. No.: 17/376,292

(22) Filed: Jul. 15, 2021

Related U.S. Application Data
(60) Provisional application No. 63/053,248, filed on Jul. 17, 2020.

(51) Int. Cl. F16L 41/02

(52) U.S. Cl. CPC F16L 41/023

(57) ABSTRACT

The present disclosure provides a pipe 10 with center influent branch 20 and opposing side influent branches 30. Each of the influent branches 20, 30 also have a concentric reducer 40 at their terminus.

### CROSS REFERENCE TO RELATED APPLICATIONS

This application claims priority to and the benefit of pending U.S. Provisional Application No. 63/053,248 filed Jul. 17, 2020.

### FIELD OF THE DISCLOSURE

The present invention relates to piping and more particularly to multi-flow pipe.

### BACKGROUND

Pipe fittings and valves control the direction and flow of fluids through piping. Often at times, the total dynamic head of the fluid is lowered as the fluid flows through the pipping. Splitting the flow between three branches of a pipe requires a manifold, double wye (or “Y”) or combination of “T” and elbow joints. These prior art approaches either have large pressure drops, and/or do not split the flow evenly across the pipe branches. The fitting of the present disclosure addresses the known issues in the prior art.

### DESCRIPTION OF FIGURES

FIG. 1 shows a perspective view of the pipe of the current disclosure.

FIG. 2 shows a side view of the pipe of the current disclosure.

FIG. 3 shows a cross-sectional view of the pipe of the current disclosure.

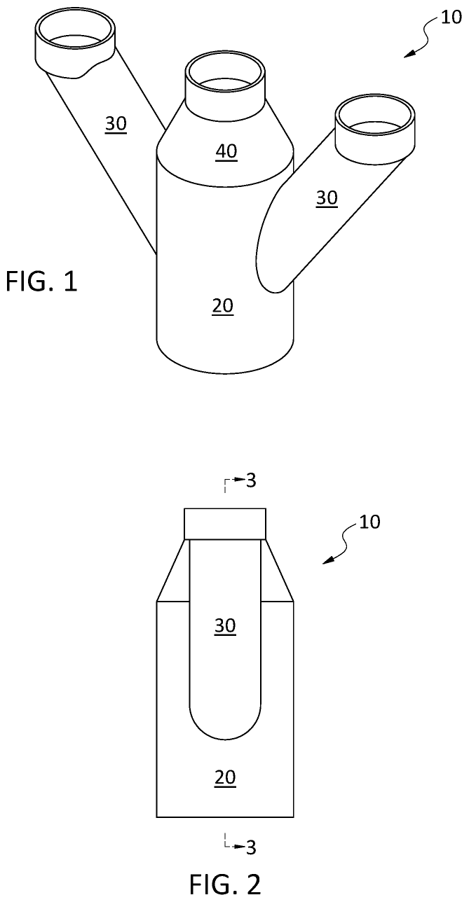

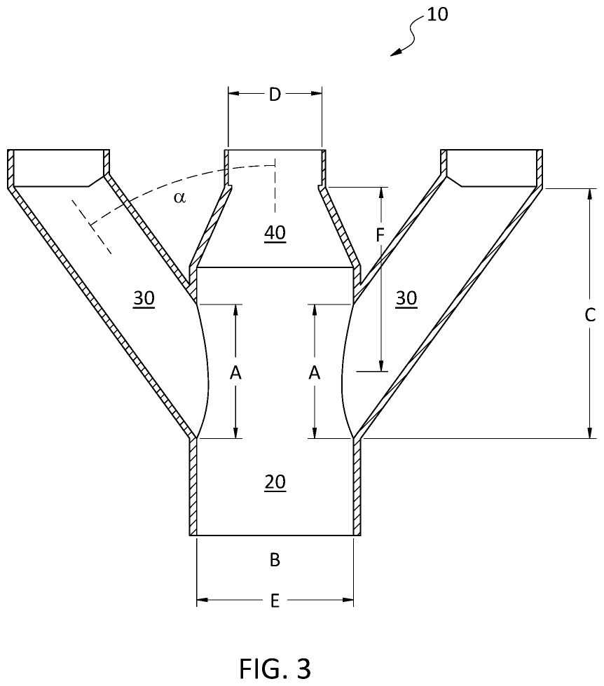

The drawings illustrate by way of example only preferred embodiments of the invention.

### DETAILED DESCRIPTION

The present disclosure provides a pipe 10 with center influent branch 20 and opposing side influent branches 30. The center influent branch 20 has a concentric reducer 40 near its terminus.

In a preferred embodiment, the side influent branches 30 join the center influent branch 20 at an acute angle, α, of between about 35 and 65 degrees and are mirror images of one another. In an alternate embodiment, α, is between 35 and 50 degrees. In yet another alternate embodiment, α is less than 45 degrees.

The side influent branches 30 join the center influent branch 20 at a junction point and form a side influent branch 30 entrance area, A. In one embodiment, the area of A is less than about 50% of the cross-sectional area B of the center influent branch 20. In yet an alternate embodiment, area of A is about 45% of the cross-sectional area B of the center influent branch 20.

Each of the side influent branch 30 entrance area A comprise a midpoint which is a distance F away from the concentric reducer 40 on the center influent branch 20 that is greater than about 25% of the center influent branch diameter E.

In one embodiment, the diameter, D, of the center influent branch's 20 concentric reducer 40 is less than the diameter of the center influent branch 20.

The pipe 10 can be manufactured from many different materials including cast iron, PVC, CPVC, HDPE, steel, fiberglass reinforced plastics and the like. Of course, one of skill in the art will recognize that the material from which the pipe 10 is manufactured will likely be dependent on the fluid being transported by the pipe 10.

The pipe 10 of the present disclosure offers many advantages over the prior art, including splitting the mass flow rate of Newtonian fluids flowing through the center influent branch 20 evenly among the three (3) influent branches without requiring any sort of outside force or system, such as a valve, and with minimum pressure drop within the pipe 10. The novel design of the pipe eliminates the requirement for the fittings, valves and larger pumps normally needed to achieve balanced flow across three (3) pipes thereby reducing both capital and operating costs.

Although embodiments of the present disclosure have been described, it is not intended that such references be construed as limitations upon the scope of this disclosure except as set forth in the claims. Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise.

I claim:

1. A pipe with a center influent branch and opposing side influent branches, wherein the side influent branches join the center influent branch at an acute of between about 35 and 65 degrees.

2. The pipe of claim 1 wherein the side influent branches are mirror images of one another.

3. The pipe of claim 1 wherein the side influent branches join the center influent branch at a junction point and thereby define a side influent branch entrance area and wherein the side influent branch entrance area is less than a cross-sectional area of the center influent branch.

4. The pipe of claim 3 wherein the side influent branch entrance areas are about 45% of the cross-sectional area of the center influent branch.

5. The pipe of claim 2 wherein the side influent branches join the center influent branch at a junction point and thereby define a side influent branch entrance area and wherein the side influent branch entrance area is less than a cross-sectional area of the center influent branch.

6. The pipe of claim 5 wherein the side influent branch entrance areas are about 45% of the cross-sectional area of the center influent branch.

7. The pipe of claim 1 wherein the center influent branches further comprise a concentric reducer.

8. The pipe of claim 7 wherein the concentric reducer has a diameter less than the diameter of the center influent branch.

9. The pipe of claim 2 wherein the center influent branch further comprises a concentric reducer.

10. The pipe of claim 9 wherein the concentric reducer has a diameter less than the diameter of the center influent branch.

11. The pipe of claim 4 wherein the center influent branch further comprises a concentric reducer.

12. The pipe of claim 11 wherein the concentric reducer has a diameter less than the diameter of the center influent branch.

13. The pipe of claim 5 wherein the center influent branch further comprises a concentric reducer.

14. The pipe of claim 1 manufactured from a material selected from the group consisting of cast iron, PVC, CPVC and HDPE.

15. The pipe of claim 5 manufactured from a material selected from the group consisting of cast iron, PVC, CPVC and HDPE.

16. The pipe of claim 12 manufactured from a material selected from the group consisting of cast iron, PVC, CPVC and HDPE.

17. The pipe of claim 3 wherein the side influent branch entrance areas comprise a midpoint which is a distance away from the concentric reducer on the center influent branch that is greater than about 25% of the center influent branch diameter.

18. The pipe of claim 4 wherein the side influent branch entrance areas comprise a midpoint which is a distance away from the concentric reducer on the center influent branch that is greater than about 25% of the center influent branch diameter.
